(19) United States
(12) Patent Application Publication
(10) Pub. No.: US 2024/0207856 A1
(43) Pub. Date: Jun. 27, 2024

(54) MULTI-CHANNEL LIQUID DISPENSER COMPATIBLE REAGENT CONSUMABLES AND WORKFLOWS

(71) Applicant: Pierce Biotechnology, Inc., Rockford, IL (US)

(72) Inventors: Eric L. HOMMEMA, Roscoe, IL (US); Deven K. ETNYRE, Poplar Grove, IL (US); Christopher L. ETIENNE, Oregon, WI (US); Caleb M. SHEARROW, Janesville, WI (US); Benjamin DAHLMEIER, Rockford, IL (US); Bridget N. JOHNSON, Rockford, IL (US); Sharon O’BRIEN, Rockford, IL (US); Abby NORTON, Rockford, IL (US)

(21) Appl. No.: 18/391,735

(22) Filed: Dec. 21, 2023

Related U.S. Application Data
(60) Provisional application No. 63/434,099, filed on Dec. 21, 2022.

(51) Int. Cl. B01L 3/00

(52) U.S. Cl. CPC B01L 3/527; B01L 3/523; B01L 2200/18; B01L 2300/021; B01L 2300/042; B01L 2300/0832

(57) ABSTRACT

Consumables for use with multi-channel liquid dispensing devices and multi-channel testing devices and workflows for use thereof are described. Consumables of the disclosure can comprise a plurality of containers, preloaded with a reagent such as, known dilutions of a reagent, such as a standard, a protein, a chemical, or other desirable material. A multi-channel liquid dispensing device can be used to simultaneously withdraw amounts of the reagent from all containers of the consumable and to further simultaneously deposit the reagent into rows of a multi-well device (such as a micro-well plate) for further downstream reactions and/or testing. Downstream testing can be in a testing machine, such as a spectrophotometer, a fluorometer, or others. Consumables of the disclosure provide advantages such as saving time over individually preparing the dilution of a reagent, and individually measuring and dispensing the reagent/dilution of reagent into each individual well of a multi-well device for downstream reactions/testing. Consumables of the disclosure can comprise multiple rows, each row comprising a consumable with multiple containers or tubes.

### RELATED APPLICATION

This application claims the benefit of U.S. Provisional Application 63/434,099, filed Dec. 21, 2022, the disclosures of which are incorporated herein in their entirety.

### BACKGROUND

### Technical Field

This disclosure generally relates to consumables that are compatible with multi-channel liquid dispensing devices and workflows using these consumables.

### Related Technology

Protein assays such as ELISAs (enzyme-linked immunosorbent assay), BCA (bicinchoninic acid assay), Bradford, and others require specific standards to determine a relative protein concentration of a sample. For ELISAs, the standard used matches the protein which is being assayed. General protein detection assays such as the BCA assay use a general protein standard, which for most purposes is BSA (Bovine Serum Albumin). These standards need to be run alongside samples in order for a quantitative concentration value (mg/ml for example) of the protein to be obtained. Standard curve graphs of the protein standard (such as BSA) are generated and relative concentrations of a protein in a sample are then calculated/determined by plotting the concentration of the protein in the sample as obtained by the assay onto the protein standard curve graph. A protein standard usually needs to be created either by the user or purchased from a commercial supplier and must be prepared in a dilution series to determine the effective range and the sensitivity of the assay. The accuracy in which the standard is made is extremely important for the overall accuracy of the protein assay. Voice of Customer surveys have indicated that preparation of the standards is one of the common pain points for performing quantitative protein assays.

Users often prepare the standard incorrectly and/or make errors transferring the standards to the appropriate assay vessel. Typically, users use an 8×12 well (96 well) microplate format and only need between 5-25 microliters of the standard added to the plate in duplicate or triplicate. Standard curves typically contain 7-8 points representing 7 different concentrations of the protein standard and a sample blank. Not counting the pipetting steps required to accurately prepare the protein standards, the user must accurately dispense 21-24 standards into the correct wells of the microplate. This is usually done with a single channel pipettor and involves retrieving standard from 7-8 different vessels potentially increasing the chance of error by selecting the wrong standard. Often these assays are run in a high throughput manner which may cause ergonomic issues pipetting each of these standards into multiple plates. Manually dispensing the standards into the plate(s) using a single channel pipette can be a significant time investment especially if multiple plates are being used. Automation of these assays is often desirable once the number of samples requires many plates to save time and reduce ergonomic strain for those performing these assays.

Protein standards are commercially available for ELISAs and the BCA and Bradford protein assays. Most often a user will purchase these standards and prepare the appropriate dilutions of the protein standard appropriate for the assay. Commercial suppliers have gone the extra step for some protein standards such as BSA and Bovine Gamma Globulin (BGG) and offer them pre-diluted at the appropriate concentration needed for each assay. These commercially available pre-diluted standards are provided in 1-3 ml screw-cap plastic vials which are individually labeled with the concentration but still require each plastic vial to be opened and closed after use. These pre-diluted protein standards further require manual pipetting by users into microwell plates and they are not compatible with multichannel pipettes.

There have been attempts to address the accuracy and error issues by using electronic repeating pipettors, automated equipment, and plate guides which directs a user to dispense the correct pre-diluted standards into the correct corresponding wells. However, there is still room for user error. Additionally, it has been found that some users take a short-cut and do not run the standard every time an assay is run and use previous standard curve data to determine the protein concentration of their samples. Accordingly, the art still lacks an efficient and accurate solution for creating and dispensing diluted reagents such as protein standards.

### BRIEF SUMMARY

The present disclosure provides multi-channel pipette compatible reagent consumables and corresponding workflows that address one or more of the problems described in sections above.

One embodiment of the present disclosure comprises a consumable for use with a multi-channel liquid dispensing device. The consumable comprises a plurality of containers coupled together, each of the plurality of containers containing a different dilution of a reagent, each of the plurality of containers configured to receive a tip of a multi-channel liquid dispensing device to dispense the reagent; and one or more indicia of orientation configured to indicate which orientation to use when placing the plurality of containers in relation to the multi-channel liquid dispensing device.

Another embodiment of the present disclosure comprises a consumable comprising a plurality of rows, each of the plurality of rows comprising: a plurality of containers coupled together, each of the plurality of containers containing a different dilution of a reagent, each of the plurality of containers configured to receive a tip of a multi-channel liquid dispensing device to dispense the reagent; and one or more indicia of orientation configured to indicate which orientation to use when placing the plurality of containers in relation to the multi-channel liquid dispensing device. Consumables of the disclosure can comprise one or more covers that include seals, caps or lids. Plurality of containers of a consumable can include tubes, vials, wells, trays, or any receptacle or vessel with a dividing wall or surface to create multiple containers.

Another embodiment of the present disclosure comprises a method of using a consumable that is compatible with a multi-channel pipette device. The method comprises: 1) removing one or more covers from a plurality of containers comprising a consumable, each of the plurality of containers of the consumable containing a different dilution of a reagent, each of the plurality of containers comprising a top that is compatible with receiving a multi-channel pipette tip of a multi-channel liquid dispenser, the consumable further comprising one or more indicia of orientation configured to indicate which orientation to use when placing the plurality of containers in relation to the multi-channel liquid dispenser; and placing each multi-channel pipette tip of the multi-channel liquid dispenser into a respective one of the plurality of containers to draw out the different dilutions of the reagent into the multi-channel pipette tips according to the one or more indicia of orientation. The method further comprises dispensing the different dilutions of reagent from the multi-channel liquid dispenser into one or more wells of a multi-well container (and can include dispensing reagent into one or more rows of wells of the multi-well container).

In some embodiments of a method of the disclosure, one or more wells of the multi-well container can contain one or more additional materials (such as, substances, chemicals, biochemicals, or additional reagents) that react with and form a detectable reaction with the reagent comprised in the consumable and the method can further comprise detecting the reaction formed in the one or more wells of the multi-well container.

In some alternative embodiments of a method of the disclosure, the method can further comprise a step of adding one or more additional material (such as, substances, chemicals, biochemicals, or additional reagents) to the one or more wells of the multi-well container, where the material that can react with the reagent and form a detectable reaction. The method can further comprise detecting the reaction formed in the one or more wells of the multi-well container.

A further embodiment under the present disclosure comprises a method of testing one or more substances or reagents in a multi-well plate. The method comprises using a multichannel liquid dispensing device to dispense a quantity of a reagent into one or more wells of a multi-well container, the reagent contained in a consumable, the consumable comprising; a plurality of containers configured to receive a tip of the multichannel liquid dispensing device, each of the plurality of containers containing a different dilution of the reagent; and one or more indicia of orientation configured to indicate which orientation to use when placing the plurality of containers of the consumable in relation to the multichannel liquid dispensing device. The method further comprises adding to the one or more wells of the multi-well container one or more substances to form a reaction between the reagent and the one or more substances; inserting the multi-well container into a receptacle of a testing machine; and exciting the reaction in the plurality of wells of the multi-well container with one or more light sources. Further steps can include measuring an output of the excitation. The measuring can comprise, for example, measuring: an extinction of light; a colorimetric property; a fluorescence level; a luminescence; or a chemiluminescent property.

A further embodiment under the present disclosure comprises a method of testing one or more substances or reagents in a multi-well plate. The method comprises dispensing a reagent into a plurality of wells comprising the multi-well plate from a consumable, wherein the consumable comprises: a plurality of containers coupled together, each of the plurality of containers containing a different dilution of the reagent, each of the plurality of containers configured to receive a tip of a multi-channel liquid dispensing device to dispense the reagent; and one or more indicia of orientation configured to indicate which orientation to use when placing the plurality of containers in relation to the multi-channel liquid dispensing device. The method can further comprise adding to the multi-well plate one or more substances to form a reaction between the reagent and the one or more substances; inserting the multi-well plate into a receptacle of a testing machine; exciting the reaction in the plurality of wells with one or more light sources; and measuring an output of the excitation. The output of excitation can be used to detect or quantify the one or more substance or the reagent. Measuring an output of excitation can comprises measuring one or more of: an absorbance; an extinction of light, a colorimetric property; a fluorescence level; a luminescence; and a chemiluminescent property. A testing machine can comprise at least one of: a fluorometer; a plate reader; a luminometer; a colorimeter; a chemiluminescence reader; and a spectrophotometer. In some embodiments of the method, testing one or more substances or reagents comprises detecting or quantifying the one or more substances or reagents.

Another embodiment of the present disclosure includes a method of testing one or more substances in a multi-well plate. The method comprises dispensing a reagent into a plurality of wells of the multi-well plate from a consumable, wherein the consumable comprises: a plurality of containers coupled together, each of the plurality of containers containing a different dilution of the reagent, each of the plurality of containers configured to receive a tip of a multi-channel liquid dispensing device to dispense the reagent; and one or more indicia of orientation configured to indicate which orientation to use when placing the plurality of containers in relation to the multi-channel liquid dispensing device. The method also includes adding to the multi-well plate one or more substances to form a reaction between the reagent and the one or more substances; inserting the multi-well plate into a receptacle of a testing machine; subjecting the reaction in the plurality of wells with one or more light sources; and measuring an output of the reaction. In some examples the measuring can comprise measuring one or more of: an absorbance; an extinction of light, a colorimetric property; a fluorescence level; a luminescence; and a chemiluminescent property. An additional step can include obtaining a standard curve corresponding to the different dilutions of the reagent by plotting the reaction and the different concentrations of the reagent on axes of a graph. Other additional steps can include dispensing samples with unknown concentrations of the reagent into one or more empty rows of the multi-well plate; mixing the samples with one or more substances in the one or more empty rows to promote a plurality of detectable reactions; and plotting the plurality of detectable reactions on the standard curve to extrapolate values for the samples of unknown concentrations. Accordingly, reagent concentrations can be detected and quantitated by the methods described herein that are facilitated by consumables of the disclosure.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

The foregoing has outlined rather broadly the features and technical advantages of the present disclosure in order that the detailed description of the embodiments that follows may be better understood. Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims or may be learned by the practice of the disclosure as set forth hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope. The disclosure will be described and explained with additional specificity and detail through the use of the accompanying drawings in which:

FIGS. 1A to 1B illustrate an exemplary consumable embodiment of the present disclosure;

FIGS. 2A to 2F illustrate exemplary consumable embodiments of the present disclosure;

FIG. 3 illustrates an exemplary thermal seal embodiment of the present disclosure;

FIG. 4 illustrates an exemplary embodiment of pipetting a consumable into a multi-well plate of the present disclosure;

FIG. 5 illustrates an exemplary spectrophotometer embodiment of the present disclosure;

FIG. 6 illustrates an exemplary workflow for using a consumable that is compatible with a multi-channel dispensing device of the present disclosure;

FIG. 7 illustrates an exemplary workflow for testing one or more substances in a multi-well plate of the present disclosure; and

FIG. 8 illustrates a comparison of time spent in generating standard curves by existing methods in comparison to an exemplary workflow of the present disclosure.

### DETAILED DESCRIPTION

Before describing various embodiments of the present disclosure in detail, it is to be understood that this disclosure is not limited to the parameters of the particularly exemplified systems, methods, apparatus, products, processes, kits, and/or Examples which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments and is not necessarily intended to limit the scope of the claimed invention.

Consumables for use with multi-channel liquid dispensing devices and multi-channel testing devices and workflows for use thereof are described. Consumable of the disclosure comprise a plurality of containers, preloaded with a reagent such as, known dilutions of any reagent, a standard, a protein, a chemical, a biochemical, a nucleic acid, or other desirable material. A multi-channel liquid dispensing device can be used to simultaneously withdraw amounts of the reagent from all containers of a consumable of the disclosure and to further simultaneously deposit the reagent into multiple wells and/or rows of a multi-well container device (such as a micro-well plate) for further downstream reactions and/or testing. Downstream testing can be performed in a testing machine, such as a spectrophotometer, a fluorometer, or others. Consumables of the disclosure provide advantages such as saving time over individually preparing the dilution of a reagent, and individually measuring and dispensing the reagent/dilution of reagent into each individual well of a multi-well device for downstream reactions/testing. Consumables of the disclosure can comprise multiple rows, each row comprising a consumable with multiple containers or tubes.

Embodiments under the present disclosure include a multichannel pipette compatible (MCPC) tube format consumable containing a pre-diluted reagent, such as protein standard of interest for microplate-based protein assays, ELISAs, or a nucleic acid standard for determining the concentration of a nucleic acid, or any other chemical or biochemical including and other testing standards that can be used in a variety of assays and systems. Such embodiments can solve multiple challenges present in the prior art. Features of certain embodiments can include one or more of the following:
A consumable and the plurality of its containers containing a reagent can be in the appropriate spacing for direct pick-up with a multichannel pipette and also for direct dispense of the samples to a standard microplate (commonly comprising 96 wells).
The containers of a consumable of the disclosure can be spaced to be easily used in automated liquid handlers.
The consumable can have one or more indicia of orientation configured to indicate which orientation to use when placing the plurality of containers in relation to the multi-channel liquid dispensing device.
The containers of a consumable of the disclosure can be connected so that the order of the concentration of a reagent, such as a pre-diluted reagent (e.g., a protein standard or a nucleic acid standard) contained therein is not disturbed.
The containers of a consumable of the disclosure can be thermally sealed with a foil to prevent leaking and evaporation.
A foil tab can be included on a seal to make the consumable easier to open and to add an additional layer of orientation to the loading order of the reagents contained in the consumable including dilutions of reagents.
The individual containers of a consumable can be readily opened and sealed again with a single-strip cap for multiple uses.
The consumable can be supplied in a holder for convenient dispensing or pipetting of reagents out of the individual containers of the consumable to improve the ease of dispensing and pipetting.

Embodiments include consumables comprising a plurality of containers (e.g., tubes) that can ease the process of adding reagent or other materials into wells or other containers of a multi-well type device (e.g., multi-well plate). Multi-well devices can then be inserted into a multi-channel testing device for further downstream processing of the reagent and any other materials added therein.

Consumable embodiments described herein can be compatible with multi-channel pipette devices (either manual or automated ones). Embodiments also include groups of consumables, e.g., a group of 10, 12, 16, 20, or more consumables coupled together, each consumable comprising a plurality of containers. Such groups of consumables can also be called consumables. Embodiments further include removable covers or caps for consumables.

Embodiments also include methods of using the consumables of the present disclosure.

Embodiments of a plurality of containers described herein can include e.g., an eight-container, or a ten container, or a twelve container or more consumable that is pre-packaged with a reagent or a material such as for example various dilutions of a reagent or other material. Such embodiments allow a multi-channel liquid dispensing device, such as multi-channel pipettes to withdraw and dispense the reagent or other material from the tubes to another multi-well container (such as a multi-well plate) in a single step. Currently available pre-diluted standards are available in individual screw cap vials and tubes and are not available in a multi-channel dispenser compatible format. The multi-channel dispenser compatible format of the consumables of the present disclosure, provide one or more advantages to a user such as: consistent pipetting of diluted reagents/materials from the consumable to a multi-well container for further downstream reactions with the reagent/materials, ability to automate or semi-automate a testing assay where a reagent/material/dilution of reagents needs to be pipetted/dispensed into a plurality of containers, decreasing the time spent in dispensing reagents, decreasing error rate in pipetting the correct dilution of a reagent/dilution of a reagent/material into multiple containers.

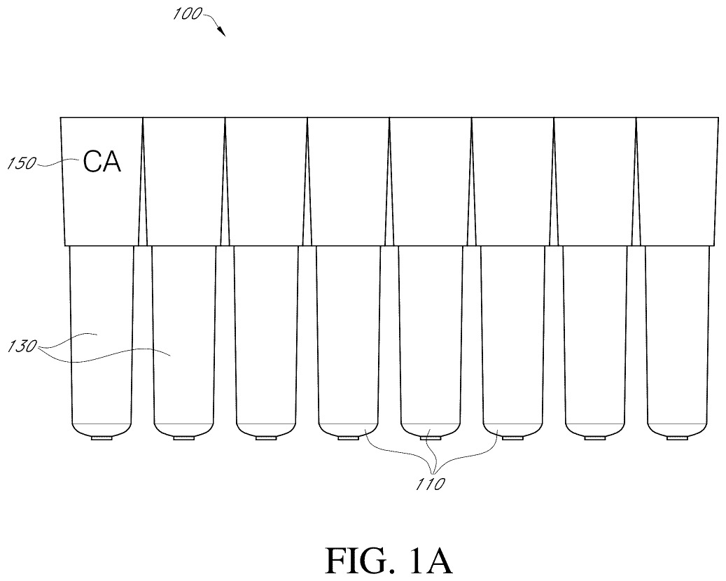

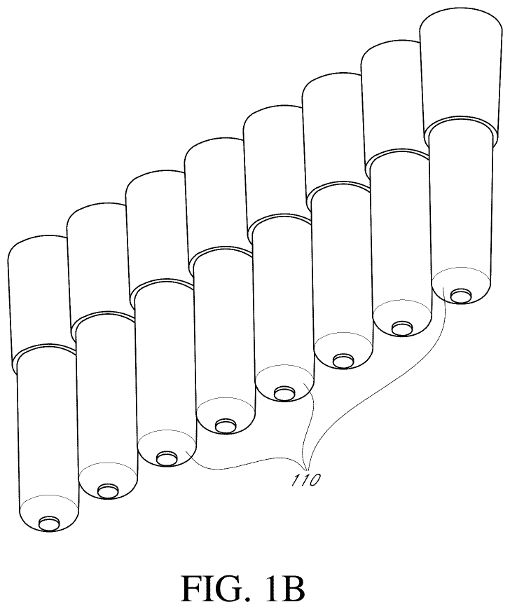

FIGS. 1A and 1B illustrate a consumable embodiment under the present disclosure. Consumable 100 comprises a plurality of containers, in this embodiment tubes 110. In this embodiment the tubes 110 are coupled together in a row of eight. Other numbers of tubes 110 (two, four, six, 10, 12, 16, 20, etc.), types of containers, and coupling (single row, 4×2, 10×7, other arrangements) are possible. Each tube 110 has a different dilution of reagent 130 within. An indicum 150 of orientation is optional. Indicia 150 can comprise letters, numbers, shapes, arrows, colors, or other markings or physical components or apparatuses that indicate how the consumable is to be oriented with a multi-channel liquid dispensing device or how a user should insert a manual multi-channel pipetting device into the tubes 110. Indicia 150 can be located on one tube 110, all tubes 110, some of tubes 110, or on a cap or seal (not shown here) attached to the consumable 100. Indicia 150 can include tabs, holes, or other protrusions or deformations of consumable 110 or from a cap. Tubes 110 are preferably coupled together such as at or near a top surface. Tubes 110 have open ends to enable liquid dispensing (e.g., pipetting).

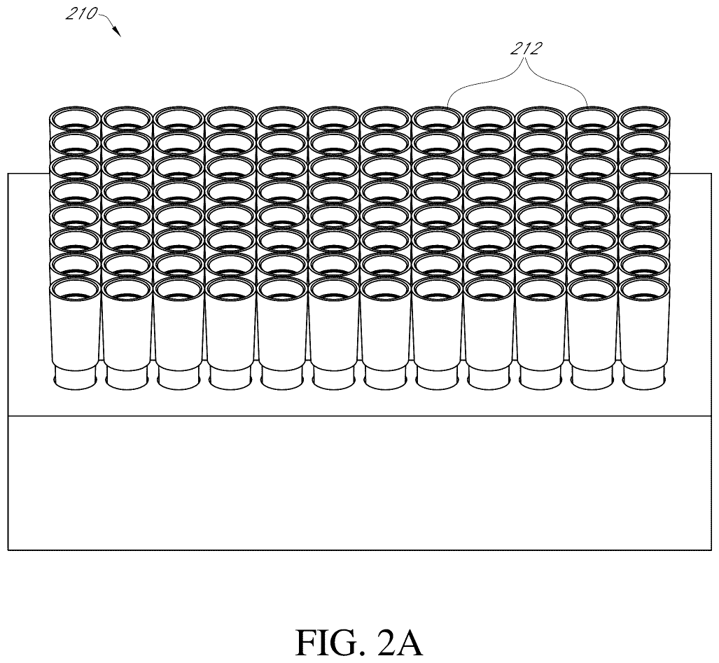

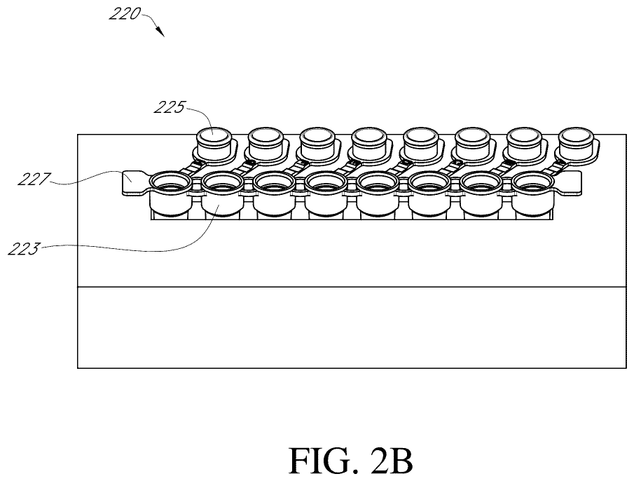

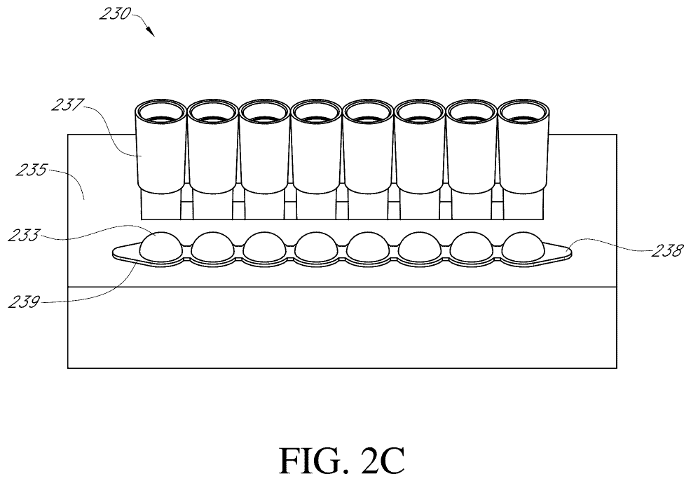

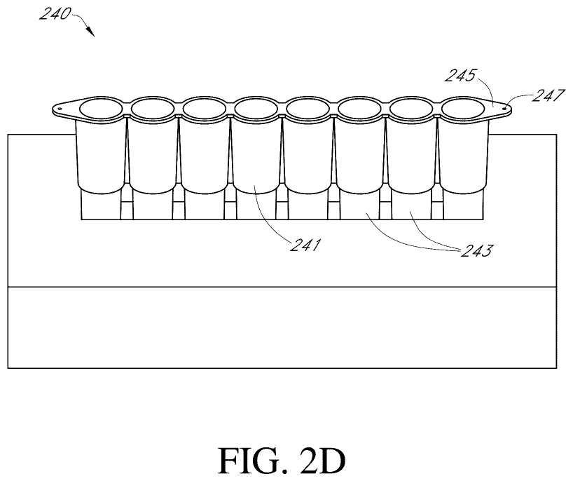

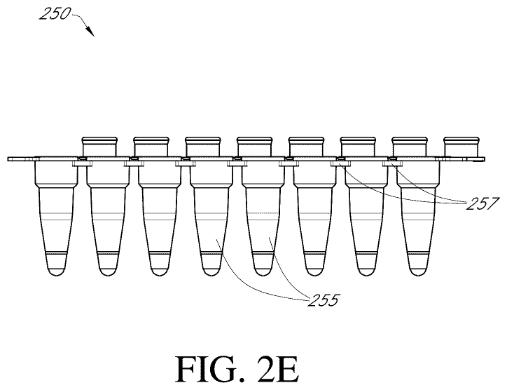

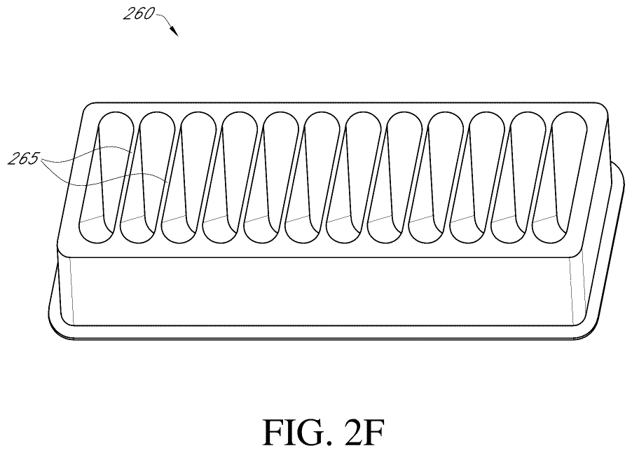

FIGS. 2A-2F illustrate various possible embodiments of consumables under the present disclosure.

FIG. 2A shows a consumable 210 with multiple columns 212, each column 212 comprising a consumable such as consumable 100 of FIGS. 1A-1B. Columns 212 can all be coupled together, preferably so that an individual column 212 can be torn away, cut away, or otherwise easily removed from the other columns 212 by a user.

FIG. 2B illustrates a consumable 220 wherein each container 223 has its own removable cap 225. Tabs 227 can comprise indicia of orientation.

FIG. 2C illustrates a consumable 230 with a single integrated cap 235 with multiple domes 233 configured to couple to each container 237. Tabs 239 can comprise indicia of orientation, such as hole 238.

FIG. 2D illustrates a consumable 240 with tabs 245 extending therefrom. Hole 247 can comprise an indicum of orientation. In consumable 240, the individual tubes 243 are coupled together by a sheath 241 coupling the tubes 243 together around a top half of the tubes 243. Sheath 241 is physically integrated into the consumable 240.

FIG. 2E shows a side view of a consumable 250. In consumable 250, the tubes 255 are coupled together at a top surface 257 of each tube 255.

FIG. 2F shows a consumable 260. Consumable 260 helps to illustrate that containers 265 do not have to comprise tubes, such as in other embodiments. Consumable 260 is more similar to a tray with multiple slots.

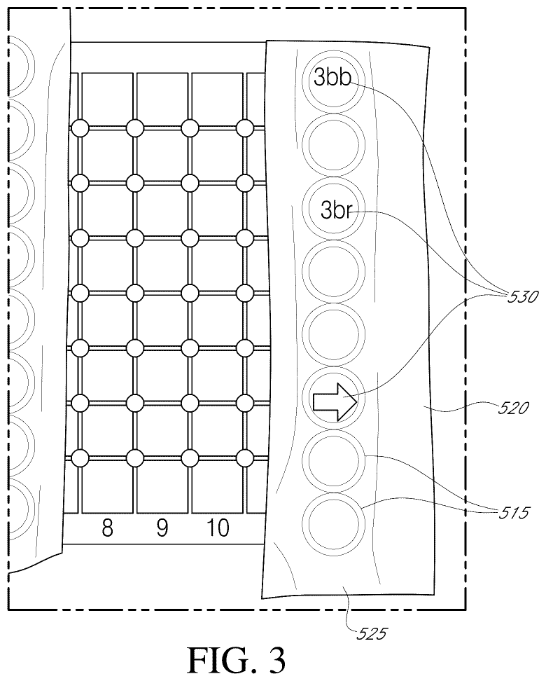

FIG. 3 shows a thermal seal 520 coupled to the top of a consumable (not shown) comprising eight containers 515. Thermal seal 520 can comprise an overhang 525 that can make it easier to grab thermal seal 520 and remove it from the consumable. Thermal seal 520 can comprise a variety of markings 530. Markings 530 can indicate contents of the respective container 515, indicia of orientation, a reagent type, or other information. Thermal seal 520 can comprise an aluminum or other metal seal or can comprise other materials. Thermal seal 520 can be coupled to a single consumable (e.g., a row of eight tubes), or a plurality of consumables (e.g., a group of five, eight, 10 or any number of consumables).

In a typical embodiment, a group of consumables may be delivered to a customer with a thermal seal attached. The consumables may comprise a plurality of containers with standard dilutions of reagent preloaded therein. After a first use (and taking off of the thermal seal) a user may then couple a cover, such as caps 225 of FIG. 2B or cap 235 of FIG. 2C, to the consumables to protect the contents for use at a later time.

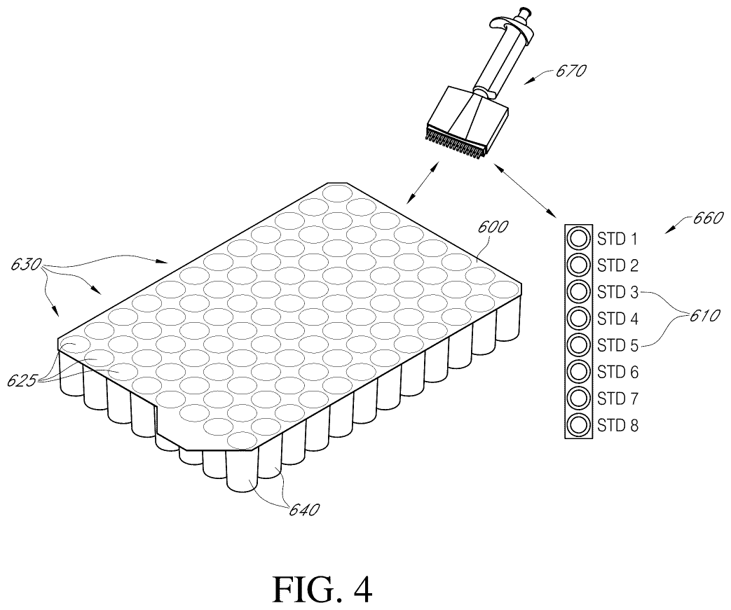

FIG. 4 illustrates a consumable 660 embodiment and how it might be used with a multi-channel liquid dispensing/pipette device 670 and a multi-well plate 600. Consumable 660 has multiple containers 610 and can have a marking such as a color code, a printed text or number or symbol, have a physical feature (such as a hole or a tab) or bear any other indicia markings to show different concentrations or dilutions of a given reagent. The marking can comprise an indicia of orientation of the consumable. Multi-well plate 660 can comprise a typical multi-well container used for biological or chemical testing assays. Such multi-well containers can be placed in spectrophotometers, fluorometers, luminometers, plate readers, and other types of testing machines. Multi-well plate 600 comprises rows 630 and columns 625 each with a plurality of wells 635 (in this case, and by way of example only, eight wells in a row 630 and 12 wells in a column 625). Wells 635 may already contain a test material, a protein, a nucleic acid, a biochemical, a chemical, or other reagents, or other substances that can react with the pre-diluted reagent in the consumable to form a detectable reaction. Alternatively, these materials can be added later on into the wells 635 of the multi-well plate 600. Multi-channel pipette device 670 can be manual or part of an automated machine. A user (manually or via automated means, such as programming a machine) may wish to pipette reagent from consumable 660 into each row 630 of multi-well plate 600. In prior art approaches, this would need to be done one pipette and one container 610 at a time. Under the present disclosure, multi-channel pipette device 670 can pipette reagent from each container 610 simultaneously, and then deposit that reagent into wells 635 of a row 630 (or even a column 625) of the multi-well plate 600 simultaneously. The multi-channel dispenser 670 compatible format of the consumables 660 of the present disclosure, provide one or more advantages to a user such as: consistent pipetting of diluted reagents/materials from consumable 660 to a multi-well container 600 which can be used for further downstream reactions with other test materials/other reagent/substances. This also allows ability to automate or semi-automate a testing assay where a reagent/material/dilution of reagents needs to be pipetted/dispensed into a plurality of containers, decreasing the time spent in dispensing reagents, decreasing error rate in pipetting the correct dilution of a reagent/dilution of a reagent/material into multiple containers.

In some cases, where further downstream reactions are carried out, several test rows 640 of multi-well plate 600 may be reserved for standardization purposes. These test rows 640 may not be used with a second material and may only receive reagent from consumable 660. When the test rows 640 are tested in a testing machine such as in a spectrophotometer/fluorometer/etc., the detected light/color/change in excitation/property should confirm the standard dilutions of the reagent as indicated by the indicia of orientation. Test material such as proteins, other reagents, or other substances can be added to each well 635 before or after the pipetting of the reagent from consumable 660 to allow for a reaction to form between the reagent from the consumable and the test material in the well to form a detectable reaction. Depending on the specific tests desired, additional substances/reagents/chemicals/stimuli as well as an incubation period may be required to allow a detectable reaction to from as well. FIG. 4 illustrates the components and steps of a workflow using a multi-channel liquid dispenser compatible consumable of the present disclosure.

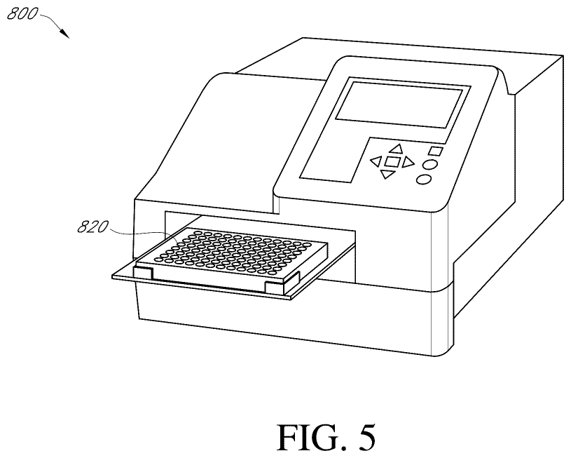

FIG. 5 illustrates an exemplary testing machine, depicted here as an example spectrophotometer 800 that can test a multi-well plate 820. Multi-well plate 820 can be inserted into spectrophotometer 800 after being loaded with reagent from a consumable and with a test material or other desired substance. Spectrophotometer can excite or illuminate each well and detect an output. However, one of skill in the art, in light of this disclosure will realize that any other testing machine, such as a fluorometer; a plate reader; a luminometer; a chemiluminescence detector and the like can be used in place of the spectrophotometer 800 which is used herein as an exemplary testing machine to describe workflows and methods of the disclosure. Continuing from the exemplary workflow and method embodiments described in FIG. 4 and other sections above, after forming a reaction in one or more wells of multi-well plate 820 between one or more test substances or materials added to or contained in the multi-well plate wells and the reagent from the consumable, the multi-well plate can be inserted into a receptacle of a testing machine 800. Testing machine 800 can be used to cause excitation of the reaction in the plurality of wells with one or more light sources and to then measuring an output of the excitation of the reaction. The output of excitation can be used to detect or quantify the one or more substance or the reagent. Measuring an output of excitation can comprises measuring one or more of: an absorbance; an extinction of light, a colorimetric property; a fluorescence level; a luminescence; and a chemiluminescent property. In some embodiments of the method, testing one or more substances or reagents comprises detecting or quantifying the one or more substances or reagents.

The embodiments described herein provide numerous benefits. One benefit is an automation capability wherein the consumables of the disclosure allow for automation of any microplate assays since the consumable can be made to have any number of containers, in any shape and further in any combination of rows and columns and container numbers to match the format of any liquid handling device, any robotic liquid dispenser, and any multi-channel liquid dispensing device. Another benefit is a reduction in time wherein a reduction of the number of liquid dispensing/pipetting steps, and the number of opening and closing steps for each of the individual standard containers or tubes is reduced. A further benefit is accuracy, wherein pre-diluted reagents (e.g., protein standards, nucleic acid standards, chemical standards, etc.) can be prepared in a manufacturing setting with appropriate quality control specifications in place. Additionally, there can be substantial reduction of loading errors, wherein a multi-channel pipette can simultaneously withdraw all of the pre-diluted reagents in a consumable in one step and deposit them into corresponding wells of a multi-well container, guided by the indicia of orientation, (e.g., all the protein standards needed for a protein standard curve can be withdrawn from a consumable of the disclosure and deposited into corresponding wells of a multi-well container in one step), reducing the chances of loading wrong dilutions into wells due to user errors in: 1) withdrawing, 2) depositing, and 3) picking a reagent with incorrect dilution, as well as by reducing the number of pipetting steps. In one example where the pre-diluted reagent includes protein standards, the protein standards can be marked with indicia labeling the highest (or lowest) protein concentration at the top-most container of the consumable to ensure the loading orientation into the microplate is correct.

An exemplary consumable may be preloaded with reagent and/or standard solutions. Testing standards used could be proteins such as BSA, BGG, IgG (immunoglobulin G) proteins for ELISA or other, enzymes, or other peptides, nucleic acids, and chemical compounds. For example, a consumable can be loaded with pre-diluted BSA standards such as, but not limited to, 2000 μg/ml, 1500 μg/ml, 1000 μg/ml, 750 μg/ml, 500 μg/ml, 250 μg/ml, 125 μg/ml to be used with any protein concentration detection assays such as but not limited to BCA, Lowry, and Bradford based protein assays. These amounts can vary by +/−5%.

Another possibility is BSA standards at ranges such as, but not limited to, 10000 μg/ml, 5000 μg/ml, 2000 μg/ml, 1000 μg/ml, 500 μg/ml, 250 μg/ml, or 125 μg/ml range assays.

A single row of consumables may be loaded with a wide variety of dilutions, from picogram to milligram and even up to gram levels e.g., per milliliter. In some embodiments, ELISA protein standards can be used, such as intracellular proteins or extracellular proteins. Examples of intracellular proteins can include phospho-proteins, cyclins, and nuclear transcription factors. Examples of extracellular proteins can include cytokines or biomarkers found in whole blood, serum or plasma. Chemical standards used could be glutathione for use in an Ellman's assay, N-ethyl maleimide for a maleimide concentration assay. Other example pre-diluted reagents that used could be loaded in a consumable of the disclosure include a protein-fluorophore conjugate, a DNA standard, an RNA standard (DNA and RNA standards are common in e.g., fluorometric assays), a chemical standard, or others.

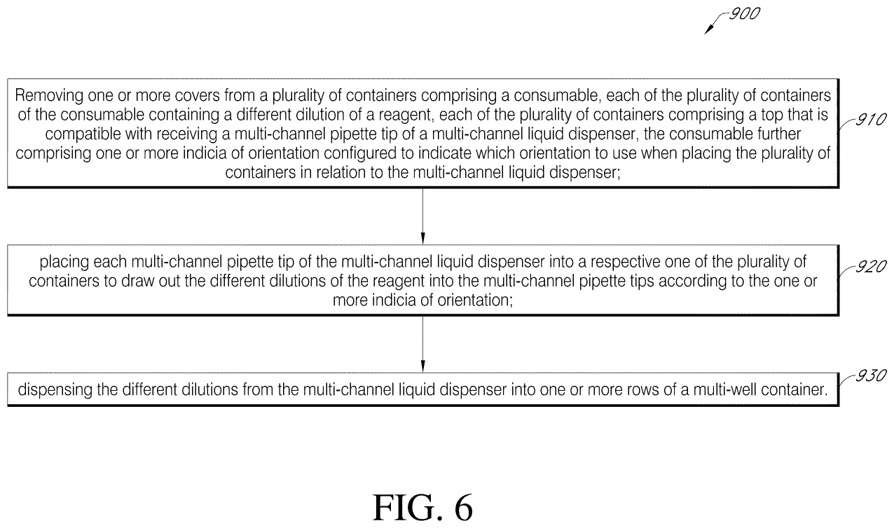

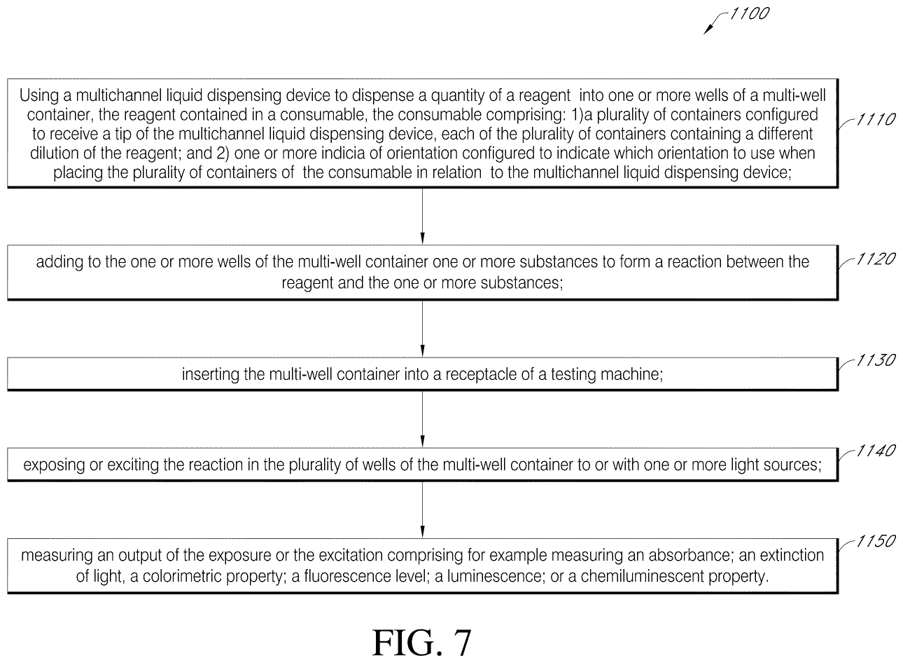

FIGS. 6 and 7 illustrate flow charts of possible method embodiments under the present disclosure.

Method 900 of FIG. 6 is a method of using a consumable that is compatible with a multi-channel pipette device. Step 910 comprises removing one or more covers from a plurality of containers of a consumable, each of the plurality of containers of the consumable containing a different dilution of a reagent, each of the plurality of containers comprising a top that is compatible with receiving a multi-channel pipette tip of a multi-channel liquid dispenser, the consumable further comprising one or more indicia of orientation configured to indicate which orientation to use when placing the plurality of containers in relation to the multi-channel liquid dispenser. Step 920 comprises placing each multi-channel pipette tip of the multi-channel liquid dispenser into a respective one of the plurality of containers to draw out the different dilutions of the reagent into the multi-channel pipette tips according to the one or more indicia of orientation. Step 930 comprises dispensing the different dilutions from the multi-channel liquid dispenser into one or more rows of a multi-well container.

Method 900 can comprise a variety of variations and additional or alternative steps. For example, the one or more rows can contain one or more additional materials configured to promote a detectable reaction with the reagent. In some embodiments, the method can further comprise depositing one or more additional materials into the one or more rows that are configured to promote a detectable reaction with the reagent. The one or more additional materials can comprise one or more of chemicals, other reagents, proteins, or other substances. An additional step can comprise detecting a reaction within the one or more rows/wells. In some embodiments the detecting can comprise one or more of: colorimetry; absorbance; fluorescence; luminescence; and chemiluminescence. These methods can be used to detect the presence of the reagent or the substance/material.

The method can optionally further include generating a standard curve by plotting the detectable reaction corresponding to the different dilutions of the reagent on a graph.

Some embodiments can further include dispensing samples with unknown concentrations of the reagent into one or more empty rows of the multi-well container; mixing the samples with one or more substances in the one or more empty rows to promote a plurality of detectable reactions; and plotting the plurality of detectable reactions on the standard curve to extrapolate values for the samples of unknown reagent/substance concentrations. These methods can be used to quantify the reagent or the substance.

In some cases, the method can include placing one or more caps on the plurality of containers, the one or more caps coupled together and configured to be coupled to the plurality of containers after the one or more covers has been removed. In some cases, the detecting can be performed by one or more of a fluorometer, a plate reader, a luminometer, a colorimeter, a chemiluminescence reader, and a spectrophotometer.

Method 1100 of FIG. 7 is a method of testing one or more substances in a multi-well plate. Step 1110 comprises using a multichannel liquid dispensing device to dispense a quantity of a reagent into one or more wells of a multi-well container, the reagent contained in a consumable, the consumable comprising: 1) a plurality of containers configured to receive a tip of the multichannel liquid dispensing device, each of the plurality of containers containing a different dilution of the reagent; and 2) one or more indicia of orientation configured to indicate which orientation to use when placing the plurality of containers of the consumable in relation to the multichannel liquid dispensing device. Step 1120 is adding to the one or more wells of the multi-well container one or more substances to form a reaction between the reagent and the one or more substances. Step 1130 is inserting the multi-well container into a receptacle of a testing machine. Step 1140 is exposing or exciting the reaction in the plurality of wells of the multi-well container to/with one or more light sources. Step 1150 is measuring an output of the excitation (or exposure). Examples of measuring an output of the exposure or excitation to a light include measuring: an absorbance; an extinction of light, a colorimetric property; a fluorescence level; a luminescence; or a chemiluminescent property.

Method 1100 can comprise a variety of variations and additional or alternative steps. In some embodiments the measuring can be done by analyzing one or more of an absorbance, a colorimetric property, a fluorescence level, a luminescence, a chemiluminescent property, or another characteristic. The method can also include obtaining a standard curve corresponding to the different dilutions of the reagent by plotting the reaction and the different concentrations of the reagent on axes of a graph. This can further include dispensing samples with unknown concentrations of the reagent into one or more empty rows of the multi-well plate; mixing the samples with one or more substances in the one or more empty rows to promote a plurality of detectable reactions; and plotting the plurality of detectable reactions on the standard curve to extrapolate values for the samples of unknown concentrations. In some embodiments, the testing machine can comprise at least one of a fluorometer, a plate reader, a luminometer, a spectrophotometer, or another type of testing machine.

### Abbreviated List of Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent,” and the like are used herein solely to indicate relative directions and are not otherwise intended to limit the scope of the disclosure and/or claimed invention.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention itemed. Thus, it should be understood that although the present invention has been specifically disclosed in part by preferred embodiments, exemplary embodiments, and optional features, modification and variation of the concepts herein disclosed may be resorted to by those skilled in the art, and such modifications and variations are considered to be within the scope of this invention as defined by the appended items. The specific embodiments provided herein are examples of useful embodiments of the present invention and various alterations and/or modifications of the inventive features illustrated herein, and additional applications of the principles illustrated herein that would occur to one skilled in the relevant art and having possession of this disclosure, can be made to the illustrated embodiments without departing from the spirit and scope of the invention as defined by the items and are to be considered within the scope of this disclosure.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques specifically described herein are intended to be encompassed by this invention.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. All changes which come within the meaning and range of equivalency of the items are to be embraced within their scope.

### EXAMPLES

### Example 1

One exemplary embodiment demonstrates an advantageous reduction in setup time by using the present works-flows as compared to other commercially available protein assays.

The Pierce Dilution-Free Rapid Gold BCA Assay, which includes a workflow of the present disclosure to generate a BSA Standard Curve, reduces setup time by up to 80% compared to other protein assays. Various assays, including the Bradford Assay and the Pierce BCA Protein Assay were compared to the Pierce Dilution-Free Rapid Gold BCA Assay (which comprises a dilution workflow according to the present disclosure), were conducted following the manufacturer's protocols in a microplate format. Five cell lysates and five pure proteins were prepared to give a total of ten samples. Standard curves for the BCA and Bradford assays were generated through serial dilution of 2 mg/mL bovine serum albumin (BSA) standard. The standard curve for the Pierce Dilution-Free Rapid Gold BCA Assay was generated using Pierce Dilution-Free BSA Protein Standards (one version of the present invention) packaged in a multichannel pipette-friendly tube strip. Four of the ten samples were expected to have a starting concentration of >2 mg/mL, which necessitated a sample dilution step for the BCA and Bradford assays, whereas samples were not required to be diluted for the Dilution-Free Rapid Gold BCA Assay. Samples were then mixed with working reagent from each assay and incubated according to the manufacturer's instructions.

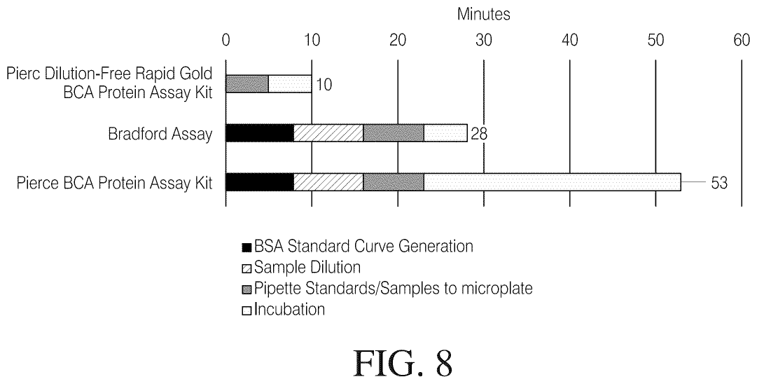

Table 1 and FIG. 8 depicts results of the above experiments and shows that the Pierce Dilution-Free Rapid Gold BCA Assay, which includes workflows of the present disclosure, has a significantly reduced setup time as compared to other commercially available protein assays. Standard curves were generated through serial dilution of 2 mg/mL bovine serum albumin (BSA) standard for the Pierce BCA Protein Assay and Bradford Assay, in contrast to the automated dilution workflow of the disclosure used in the Pierce Dilution-Free Rapid Gold BCA Assay.

TABLE 1

| | Setup time | | | | | |
|---|---|---|---|---|---|---|
| | BSA | | Pipette | | | |
| | Standard | | Standards/ | | | Sum of |
| | Curve | Sample | Samples | | Total | “Setup |
| Method/Assay | Generation | Dilution | to microplate | Incubation | Time | Time” |
| Pierce Dilution- | 0 | 0 | 5 | 5 | 10 | 5 |
| Free Rapid Gold | | | | | | |
| BCA Protein | | | | | | |
| Assay Kit | | | | | | |
| Bradford Assay | 8 | 8 | 7 | 5 | 28 | 23 |
| Pierce BCA | 8 | 8 | 7 | 30 | 53 | 23 |
| Protein Assay | | | | | | |
| Kit | | | | | | |

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A consumable for use with a multi-channel liquid dispensing device, comprising:
a plurality of containers coupled together, each of the plurality of containers containing a different dilution of a reagent, each of the plurality of containers configured to receive a tip of a multi-channel liquid dispensing device to dispense the reagent; and
one or more indicia of orientation configured to indicate which orientation to use when placing the plurality of containers in relation to the multi-channel liquid dispensing device.

2. The consumable of claim 1, wherein the plurality of containers of the consumable are coupled by being physically joined on an exterior surface.

3. The consumable of claim 1, further comprising one or more covers configured to couple to a top surface of the plurality of containers.

4. The consumable of claim 3, wherein the one or more covers comprises a plurality of lids or caps coupled together in a row.

5. The consumable of claim 3, further comprising a thermal seal coupled to the top surface of the plurality of containers, and wherein the one or more covers is configured to be coupled to the plurality of tubes after the thermal seal has been removed.

6. The consumable of claim 3, wherein the one or more covers can be detached from each other.

7. The consumable of claim 1, wherein the one or more indicia of orientation comprises one or more of: letters, text, numbers, symbols, shapes, arrows, colors, other markings or physical components.

8. The consumable of claim 1, wherein the one or more indicia of orientation comprises one or more of: a tab; an indentation; a hole.

9. The consumable of claim 8, wherein the one or more indicia of orientation are coupled to one or more of: the plurality of containers; the one or more covers; the thermal seal.

10. The consumable of claim 1, wherein the plurality of containers comprises eight tubes and the multi-channel liquid dispensing device comprises eight channels.

11. The consumable of claim 1, wherein the plurality of containers comprises twelve tubes and the multi-channel liquid dispensing device comprises twelve channels.

12. The consumable of claim 1, wherein the reagent comprises one or more of: a testing standard; a protein-fluorophore conjugate; a DNA standard; an RNA standard; a protein standard, a chemical standard.

13. The consumable of claim 12, wherein the testing standard is a protein testing standard.

14. The consumable of claim 13, wherein the protein testing standard is at least one of: Bovine Serum Albumin (BSA); Bovine Gamma Globulin (BGG); enzyme-linked immunosorbent assay (ELISA) protein standards; and immunoglobulin G (IgG) standards.

15.-20. (canceled)

21. The consumable of claim 14, wherein the plurality of containers are configured to be used with one or more of: a BCA protein assay; a Bradford protein assay; a Lowry protein assay, or other protein assays.

22. The consumable of claim 1, wherein the plurality of containers comprises at least one of: a receptacle, a tube, a test tube, a micro-tube, a vial, multi-well tubes, multi-well vials.

23. (canceled)

24. The consumable of claim 1, wherein the multi-channel liquid dispensing device comprises at least one of: a multi-channel pipette, an automated multi-channel pipette; a manual multi-channel pipette.

25. A consumable, comprising:
a plurality of rows, each of the plurality of rows comprising:
a plurality of containers coupled together, each of the plurality of containers containing a different dilution of a reagent, each of the plurality of containers configured to receive a tip of a multi-channel liquid dispensing device to dispense the reagent; and
one or more indicia of orientation configured to indicate which orientation to use when placing the plurality of containers in relation to the multi-channel liquid dispensing device.

26.-33. (canceled)

34. A method of using a consumable that is compatible with a multi-channel pipette device, the method comprising:
removing one or more covers from a plurality of containers comprising a consumable, each of the plurality of containers of the consumable containing a different dilution of a reagent, each of the plurality of containers comprising a top that is compatible with receiving a multi-channel pipette tip of a multi-channel liquid dispenser, the consumable further comprising one or more indicia of orientation configured to indicate which orientation to use when placing the plurality of containers in relation to the multi-channel liquid dispenser;
placing each multi-channel pipette tip of the multi-channel liquid dispenser into a respective one of the plurality of containers of the consumable to draw out the different dilutions of the reagent into the multi-channel pipette tips according to the one or more indicia of orientation; and
dispensing the different dilutions of the reagent from the multi-channel liquid dispenser into one or more rows of a multi-well container.

35.-44. (canceled)

45. A method of testing one or more substances in a multi-well plate, the method comprising:
using a multichannel liquid dispensing device to dispense a quantity of a reagent into one or more wells of a multi-well container, the reagent contained in a consumable, the consumable comprising:
a plurality of containers configured to receive a tip of the multichannel liquid dispensing device, each of the plurality of containers containing a different dilution of the reagent; and
one or more indicia of orientation configured to indicate which orientation to use when placing the plurality of containers of the consumable in relation to the multichannel liquid dispensing device;
adding to the one or more wells of the multi-well container one or more substances to form a reaction between the reagent and the one or more substances;
inserting the multi-well container into a receptacle of a testing machine; exposing the reaction in the plurality of wells to one or more light sources; and measuring an output of the exposure.

46.-49. (canceled)
